(19) United States
(12) Patent Application Publication
(10) Pub. No.: US 2012/0178873 A1
(43) Pub. Date: Jul. 12, 2012

(54) Copolymers of Styrene With Alkyl Acrylates and/or Alkyl Methacrylates

(75) Inventors: Jay Reimers, Houston, TX (US); Jose M. Sosa, Deer Park, TX (US)

(73) Assignee: FINA TECHNOLOGY, INC., Houston, TX (US)

(21) Appl. No.: 13/323,853

(22) Filed: Dec. 13, 2011

Related U.S. Application Data
(60) Provisional application No. 61/431,524, filed on Jan. 11, 2011.

(51) Int. Cl. C08L 25/14; C08K 5/01; C08F 220/18

(52) U.S. Cl. 524/562; 526/329.2

(57) ABSTRACT

A styrenic copolymer composition including at least one alkyl acrylate and/or alkyl methacrylate comonomer, in which the styrenic copolymer composition is optically clear and has at least two times the impact strength compared to general-purpose polystyrene.

### CROSS-REFERENCE TO RELATED APPLICATIONS

The present application is a non-provisional of U.S. Patent Application No. 61/431,524 filed on Jan. 11, 2011.

### FIELD

The present invention is generally related to the production of styrenic polymers. More specifically, the present invention is related to the production of polystyrene with copolymers to produce polymers having impact resistance and optical clarity.

### BACKGROUND

Styrene, also known, as vinyl benzene, is an aromatic compound that can be produced in industrial quantities from ethylbenzene. The most common method of styrene production is through the dehydrogenation of ethylbenzene. Polystyrene is an aromatic polymer produced from the styrene monomer. Polystyrene is a widely used polymer found in insulation, packaging, disposable cutlery, disposable medical products, food packaging, tubing, point-of-purchase displays, and foamed products such as cups.

In certain applications polystyrene does not possess desirable properties for certain uses. Therefore, copolymers of styrene have been developed in order to achieve a polystyrene having improved properties such as improved impact strength, ductility, etc. However, the manufacturing of such copolymers comes with increased costs over the traditional general-purpose polystyrene (GPPS). For example, high-impact polystyrene (HIPS) requires the addition of an elastomer. The elastomer component can add to the cost of the HIPS product and can reduce the clarity. In certain applications a high clarity is desired, however, general-purpose polystyrene while being clear can be too brittle and not possess the mechanical properties required.

It would be desirable to obtain a polystyrene copolymer having improved properties, including impact strength, while at the same time having optical properties of being clear.

### SUMMARY

Embodiments of the present invention include a styrenic copolymer composition having at least one alkyl acrylate and/or at least one alkyl methacrylate, wherein the styrenic copolymer composition is optically clear and has at least twice the impact strength compared to general purpose polystyrene. The styrenic copolymer can have an impact strength of at least 0.2 J. The alkyl acrylate can have an alkyl group with 8 to 12 carbon atoms and can be selected from the group of octyl acrylate, nonyl acrylate, decyl acrylate, undecyl acrylate, dodecyl acrylate, and combinations thereof. The alkyl methacrylate can have an alkyl group with 10 or more carbon atoms and be selected from the group of isodecyl methacrylate, endecyl methacrylate, stearyl methacrylate, and combinations thereof.

The alkyl acrylate and/or alkyl methacrylate can be present in an amount ranging from 1.0 to 30 wt. % by total weight of the composition. The composition can further include an oil having a refractive index greater than 1.40 in amounts from 0.1 to 8 wt. % by total weight of the composition.

An embodiment of the invention is a process for producing a styrenic copolymer composition by combining a styrene monomer and an alkyl acrylate comonomer and/or alkyl methacrylate comonomer to obtain a mixture. The mixture is then subjected to polymerization to obtain a styrenic copolymer composition. The styrenic copolymer composition can have at least twice the impact strength compared to polystyrene not having the alkyl acrylate comonomer or alkyl methacrylate comonomer.

The alkyl acrylate comonomer can have an alkyl group having from 8 to 12 carbon atoms and the alkyl methacrylate comonomer can have an alkyl group having at least 10 carbon atoms, and the alkyl acrylate and/or alkyl methacrylate comonomer is present in the mixture from 1.0 to 30 wt. % by total weight of the mixture. The mixture can further include mineral oil of from 0.1 to 8 wt. % by total weight of the mixture.

An alternate embodiment is a styrenic copolymer composition having at least one alkyl acrylate and/or at least one alkyl methacrylate, mineral oil of at least 0.1 wt. % by total weight of the composition. The styrenic copolymer composition can be optically clear and have at least two times the impact strength compared to general-purpose polystyrene.

The alkyl acrylate and/or alkyl methacrylate can be present in an amount of at least 15 wt. % by total weight of the composition, and the composition can have an elongation of at least 20% and a tensile impact strength of at least 0.5 J.

Another embodiment is a process for producing a styrenic copolymer composition, by combining a styrene monomer, at least one alkyl acrylate and/or alkyl methacrylate comonomer, and an oil having a refractive index ranging from 1.45 to 1.50 present in an amount of at least 0.1 wt. % by total weight of the composition to obtain a mixture and subjecting the mixture to polymerization to obtain a styrenic copolymer that is optically opaque or clear and has greater impact strength and elongation compared to general-purpose polystyrene.

The process can include the alkyl acrylate and/or alkyl methacrylate in an amount of at least 15 wt. % by total weight of the composition, the oil is present in amounts ranging from 0.1 to 8 wt. % by total weight of the mixture, and where the composition has elongation of at least 20% and a tensile impact of at least 0.5 J.

### BRIEF DESCRIPTION OF DRAWINGS

FIG. 1 depicts the contact clarity of the plaques of the copolymers obtained from the formulations of Example 1.

FIGS. 2A-2D depict the results of atomic force microscopy (AFM) of four samples of a styrenic copolymer of Example 1 along with a dimension scale in microns.

### DETAILED DESCRIPTION

Disclosed herein are styrenic copolymer compositions (SCP) and methods of preparing them. In an embodiment the SCP comprises a copolymer of styrene and an alkyl acrylate. In an embodiment the SCP comprises a copolymer of styrene and an alkyl methacrylate. In an embodiment, the SCP comprises a copolymer of styrene, an alkyl acrylate and an alkyl methacrylate. The addition of an alkyl acrylate and/or an alkyl methacrylate may result in SCPs displaying optical properties such as transparency. In addition, according to embodiments of the present invention, the styrenic copolymer may have improved strength and ductility compared to general purpose polystyrene (GPPS).

The styrenic copolymer of the present invention may include a copolymer of styrene. Styrene, also known as vinyl benzene, ethylenylbenzene, and phenylethene is an organic compound represented by the chemical formula C₈H₈. As used herein the term styrene includes a variety of substituted styrenes (e.g., alpha-methyl styrene), ring substituted styrene such as p-methylstyrene, disubstituted styrenes such as p-t-butyl styrene as well as unsubstituted styrenes.

In an embodiment, the SCP comprises a comonomer where the comonomer is an alkyl acrylate having the general chemical formula CH₂═CHCOOR wherein R represents an alkyl group having equal to or greater than 8 carbon atoms, alternatively from 8-12 carbon atoms, alternatively from 8-10 carbon atoms. Herein an alkyl group refers to a saturated hydrocarbon occurring as a side chain on a larger molecule. Examples of suitable alkyl acrylates include without limitation octyl acrylate, nonyl acrylate, decyl acrylate, undecyl acrylate, dodecyl acrylate, or combinations thereof.

In an embodiment, the styrenic copolymer includes a comonomer where the comonomer is an alkyl methacrylate having the general chemical formula CH₂═C(CH₃)COOR wherein R represents an alkyl group having equal to or greater than 10 carbon atoms. In an aspect, R represents an alkyl group having greater than 12 carbon atoms. In an embodiment, R represents an alkyl group having 12-18 carbon atoms. In another embodiment, R represents an alkyl group having 18-22 carbon atoms. The alkyl group herein may refer to a saturated hydrocarbon occurring as a side chain on a larger molecule. In an embodiment, the alkyl methacrylate is selected from the group of isodecyl methacrylate, endecyl methacrylate, and stearyl methacrylate and combinations thereof. In another embodiment, the alkyl methacrylate is selected from the group of behenyl methacrylate, C₁₈-C₂₂ alkyl methacrylate and combinations thereof. Examples of suitable alkyl methacrylates include isodecyl methacrylate, undecyl methacrylate, stearyl methacrylate or combinations thereof.

In an embodiment, the styrenic copolymer includes at least one alkyl methacrylate having an alkyl group with 12-18 carbon atoms and at least another alkyl methacrylate having an alkyl group with 18-22 carbon atoms.

In an embodiment, the styrenic copolymer includes at least one alkyl acrylate and at least another alkyl methacrylate.

The styrenic copolymer may also contain additives as necessary in order to impart desired physical properties, such as, increased gloss or color. In an embodiment, the additives are selected from the group of chain transfer agents, talc, antioxidants, UV stabilizers, lubricants, mineral oil, diluents, and plasticizers, and any combinations thereof. These additives may be included in amounts effective to impart the desired properties. For example, stabilizers or stabilization agents may be employed to help protect the polymeric composition from degradation due to exposure to excessive temperatures and/or ultraviolet light. Effective additive amounts and processes for inclusion of these additives to polymeric compositions may be determined by one skilled in the art with the aid of this disclosure. In an embodiment, additives may be present in the final product in an amount of from 0.001 wt. % to 50 wt. % of the total weight of the final copolymer, optionally from 0.1 wt. % to 30 wt. %, optionally from 0.5 wt. % to 20 wt. %. As a non-limiting example in an embodiment, chain transfer agents can be added to the process in amounts ranging from 10 ppm to 10,000 ppm, optionally from 50 to 1,000 ppm, optionally from 100 to 500 ppm. The aforementioned additives may be used either singularly or in combination to form various formulations of the composition.

In an embodiment, a method for the production of a styrene copolymer of the present invention includes dissolving a comonomer, such as an alkyl methacrylate, in styrene monomer to form a reaction mixture. The reaction mixture may then be subsequently polymerized to obtain a styrenic copolymer. The polymerization of the styrenic copolymer may be accomplished using any known method useful in preparing a styrenic copolymer, such as those described in U.S. Pat. No. 7,285,552 to Sosa et al., incorporated by reference herein in its entirety.

In an embodiment, the styrenic copolymer reaction mixture contains at least one initiator. Initiators may function as a source of free radicals to further enable the polymerization of styrene. In an embodiment, the initiator can include any initiator capable of free radical formation that facilitates the polymerization of styrene. Such initiators can include organic peroxides. In an embodiment, the organic peroxides useful for polymerization initiation are selected from the group of diacyl, peroxides, peroxydicarbonates, monoperoxycarbonates, peroxyketals, peroxyesters, dialkyl peroxides, and hydroperoxides and combinations thereof. In an embodiment, the amount of the polymerization initiator is from 0 to 1 wt. % of the monomers and co-monomers. In another embodiment, the amount of the polymerization initiator is from 0.01 to 0.5 wt. % of the monomers and co-monomers, optionally from 0.025 to 0.05 percent wt. % of the monomers and co-monomers. In an embodiment, the initiator level in the reaction mixture can be given in terms of the active oxygen in parts per million (ppm). For example, the level of active oxygen level for the production of the styrenic polymer can be from 5 ppm to 80 ppm, alternatively from 10 ppm to 60 ppm, alternatively from 20 ppm to 50 ppm. As will be understood by one of ordinary skill in the art, the selection of initiator and effective amount will depend on numerous factors (e.g., temperature, reaction time) and can be chosen by one of ordinary skill in the art with the benefits of this disclosure to meet the desired needs of the process. Polymerization initiators and their effective amounts have been described in U.S. Pat. Nos. 6,822,046; 4,861,127; 5,559,162; 4,433,099 and 7,179,873 each of which are incorporated by reference herein in their entirety.

In an embodiment, the styrenic monomers are present in a reaction mixture used to prepare the styrenic copolymer in amounts ranging from 1.0 to 99.9 wt. % by total weight of the reaction mixture (styrene+comonomer+additives). In another embodiment, the styrenic monomers are present in amounts ranging from 50 to 99 wt. % based on the total weight of the reaction mixture, optionally from 75 to 95 wt. % based on the total weight of the reaction mixture.

In an embodiment, the comonomer (alkyl acrylate and/or alkyl methacrylate) is present in a reaction mixture used to prepare the styrenic copolymer in amounts ranging from 1.0 to 30 wt. % by total weight of the reaction mixture. In another embodiment, the comonomers are present in amounts ranging from 5 to 20 wt. % based on the total weight of the reaction mixture, optionally from 8 to 18 wt. %, and optionally from 10 to 15 wt. %.

In an embodiment, the alkyl methacrylates having an alkyl group with 12-18 carbon atoms are present in a reaction mixture used to prepare the styrenic copolymer in amounts ranging from 1.0 to 30 wt. % by total weight of the mixture. In another embodiment, the alkyl methacrylates having an alkyl group with 12-18 carbon atoms are present in a reaction mixture used to prepare the styrenic copolymer in amounts ranging from 5 to 20 wt. %. In another embodiment, the alkyl methacrylates having an alkyl group with 12-18 carbon atoms are present in a reaction mixture used to prepare the styrenic copolymer in amounts ranging from 10 to 15 wt. %.

In an embodiment, the alkyl methacrylates having an alkyl group with 18-22 carbon atoms are present in a reaction mixture used to prepare the styrenic copolymer in amounts ranging from 1.0 to 30 wt. % by total weight of the mixture, optionally from 5 to 20 wt. %, optionally from 10 to 15 wt. %.

In an embodiment, a combination of the alkyl methacrylates having an alkyl group with 12-18 carbon atoms and the alkyl methacrylates having an alkyl group with 18-22 carbon atoms are present in a reaction mixture used to prepare the styrenic copolymer in amounts ranging from 1.0 to 30 wt. % by total weight of the mixture optionally from 5 to 20 wt. %, optionally from 10 to 15 wt. %. The combination of the alkyl methacrylates having an alkyl group with 12-18 carbon atoms and the alkyl methacrylates having an alkyl group with 18-22 carbon atoms can be in any ratio from 1:0 to 0:1.

Clarity of the SCP of the present invention can be modified when the refractive index (RI) of the comonomer and the refractive index of the styrene monomer are matched as closely as possible to avoid the formation of domains or particles that interact with visible light. The RI for styrene monomer is 1.549. Non-limiting examples of comonomer RI values are: methyl methacrylate at 1.414, butyl methacrylate at 1.423, hexyl methacrylate at 1.432, and stearyl methacrylate at 1.450. Additives that have an RI that are between the RI values of the styrene monomer and the comonomer can aid in the clarity of the final product by hindering the formation of domains or particles that interact with visible light. Paraffin oils, which can be referred to as mineral oil, have RI of from 1.470-1.478. Non-hydrocarbon based oils can also be used, such as safflower oil that has a RI of 1.466. Oils having a RI of greater than 1.40 can aid in the optical properties of the final product. In an embodiment oils having a RI value ranging from 1.40 to 1.55 can be used, optionally from 1.45 to 1.50, optionally from 1.46 to 1.48. RI values taken from Polymer Handbook, Interscience Publishers, 1966, and Sartomer Catalog 2010. RI normally given at 20 or 25° C. using the sodium D line.

In an embodiment the styrenic copolymer contains oil having a RI of greater than 1.40. In another embodiment the oil is combined with styrene monomer and the comonomer(s) in amounts of at least 0.1 wt. % by total weight of the mixture. In another embodiment the oil is combined with styrene monomer and the comonomer(s) in amounts ranging from 1 to 8 wt. % by total weight of the mixture. In a further embodiment the oil is combined with styrene monomer and the comonomer(s) in amounts ranging from 2 to 6 wt % by total weight of the mixture. In each of these embodiments the oil can be mineral oil, a non-hydrocarbon based oil, or combinations thereof.

The polymerization process as pertains to the present invention is not limiting and can be either batch or continuous. In an embodiment, the polymerization reaction may be carried out using a continuous production process in a polymerization apparatus including a single reactor or a plurality of reactors. The temperature ranges useful for polymerization can be from 100 to 230° C., optionally from 100 to 220° C., optionally from 100 to 200° C. In another embodiment, the polymerization temperature ranges from 110 to 180° C. In a further embodiment, the polymerization may be carried out in a plurality of reactors with each reactor having an optimum temperature range for its part in the process. For example, the polymerization may be carried out in a reactor system utilizing a first and second polymerization reactor that may be continuously stirred tank reactors (CSTR). In one embodiment, the first CSTR may be operated under temperatures ranging from 110 to 135° C., while the second CSTR may be operated under temperatures ranging from 135 to 165° C. One example of reactors and conditions for the production of a polymer composition, specifically polystyrene, are disclosed in U.S. Pat. No. 4,777,210, which is incorporated by reference herein in its entirety. The term continuously stirred tank reactor (CSTR), refers to a tank which has a rotor which stirs reagents within the tank to ensure proper mixing.

The SCP produced as described herein may display improved properties such as decreased haze, increased impact strength, and increased ductility, or combinations thereof.

In an embodiment, the SCP has a reduced haze as compared to a SCP lacking an alkyl acrylate or alkyl methacrylate comonomer. The amount of haze represents the degree to which a film has reduced clarity or cloudiness. In an embodiment, films produced from the styrenic copolymer have a haze ranging from 1 to 15%, alternatively from 2 to 10%, or alternatively from 3 to 7% as determined in accordance with ASTM D1003. In an embodiment, the SCP produced can have optical properties that are clear.

In an embodiment, the SCP has at least twice the impact strength over GPPS, optionally at least three times the impact strength over GPPS, optionally at least four times the impact strength over GPPS. In another embodiment, the impact strength of the SCP is at least 0.1 Joules (J), optionally at least 0.2 J, optionally at least 0.3 J, optionally at least 0.3 J, optionally at least 0.4 J. In a further embodiment, the impact strength of the SCP ranges from 0.2 to 0.5 J.

In an embodiment, the SCP has a glass transition temperature of less than 90° C., optionally less than 90° C., optionally less than 85° C., optionally less than 80° C., optionally less than 75° C. In another embodiment, the SCP has a glass transition temperature ranging from 50 to 90° C., optionally 55 to 90° C., optionally 60 to 90° C., optionally 65 to 87° C.

End use articles may be obtained from the polymeric compositions of this disclosure. In an embodiment, an article can be obtained by subjecting the polymeric composition to a plastics shaping process such as blow molding, extrusion, injection blow molding, injection stretch blow molding, thermoforming, and the like. The polymeric composition may be formed into end use articles including but not limited to food packaging, office supplies, house wares and consumer goods, cosmetics packaging, lids and food/beverage containers, utensils, medical supplies, and the like. In an embodiment the article can be a medical device, such as for example IV tubing, where both impact strength and clarity are desired.

### EXAMPLES

### Example 1

Several different styrenic copolymer samples were polymerized with stearyl methacrylate. The stearyl methacrylate (StMA) used was Sartomer SR324, which is commercially available from Sartomer Company, Inc., having a formula weight (FW) of 338.58, a melting point (mp) of 21.4° C., a boiling point (bp) of 235° C. (at 10 mm), and a RI of 1.4485, properties taken from product bulletin. Each sample was obtained by producing a first solution including ethylbenzene (EB), styrene monomer (S), and 200 ppm of Luperox L-233 initiator. Luperox L-233 is commercially available from Arkema, Inc. In some samples, mineral oil was also included in the first solution. Also, a second solution was obtained containing styrene monomer and stearyl methacrylate. The contents of the different solutions (runs 1-16) are shown in Table 1. The ethylbenzene is used as a diluent, is not included in the polymer chains and is lost during devolatization.

TABLE 1
Formulations of Sample Feeds

| | Solution 1 | | | Solution 2 | |
|---|---|---|---|---|---|
| Run # | EB (g) | S (g) | Mineral Oil (g) | StMA (g) | S(g) |
| 1 | 83 | 150 | 0 | 50 | 50 |
| 2 | 83 | 145 | 5 | 50 | 50 |
| 3 | 83 | 140 | 10 | 50 | 50 |
| 4 | 83 | 135 | 15 | 50 | 50 |
| 5 | 83 | 150 | 0 | 37.5 | 62.5 |
| 6 | 83 | 145 | 5 | 37.5 | 62.5 |
| 7 | 83 | 140 | 10 | 37.5 | 62.5 |
| 8 | 83 | 135 | 15 | 37.5 | 62.5 |
| 9 | 83 | 150 | 0 | 25 | 75 |
| 10 | 83 | 145 | 5 | 25 | 75 |
| 11 | 83 | 140 | 10 | 25 | 75 |
| 12 | 83 | 135 | 15 | 25 | 75 |
| 13 | 83 | 150 | 0 | 12.5 | 87.5 |
| 14 | 83 | 145 | 5 | 12.5 | 87.5 |
| 15 | 83 | 140 | 10 | 12.5 | 87.5 |
| 16 | 83 | 135 | 15 | 12.5 | 87.5 |

In the production of the styrenic copolymer samples, the first solution was subjected to a temperature profile of 135° C. for 2 hours followed by 150° C. for 2 hours, or until reaching 75% solids. 20 mL of the second solution was added to the first solution at 45 minute increments over the full length of the polymerization to ensure even distribution of the StMA comonomer throughout the styrenic copolymer.

At the end of the polymerization, the final reactor contents were devolatilized at 450° F. (232° C.) for 40 minutes. The glass transition temperatures of the devolatilized samples were obtained by differential scanning calorimetry (DSC). These samples were then compression molded to obtain 30 mil thickness plaques. Test strips were then stamped out of the plaques.

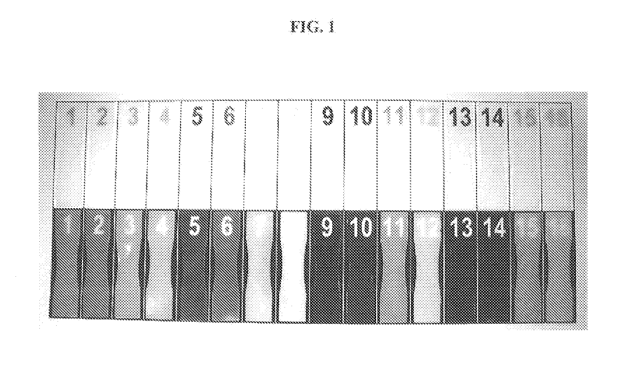

Contact clarity was characterized, and is shown in FIG. 1. Of the sixteen samples made, six are considered optically clear, four possessed varying amounts of haziness, and the remainders were opaque. The four clear samples, Runs 5, 6, 9, 10, 13 and 14 were those produced with 5, 10 or 15 wt % StMA and contained either 2 wt % or no mineral oil. For a comparison, Total 517, a general purpose polystyrene containing 5 wt % mineral oil, exhibits haziness. Therefore, the fact that a polystyrene having a total loading of from 5 wt % up to 17 wt % of immiscible ingredients produced clear samples was surprising.

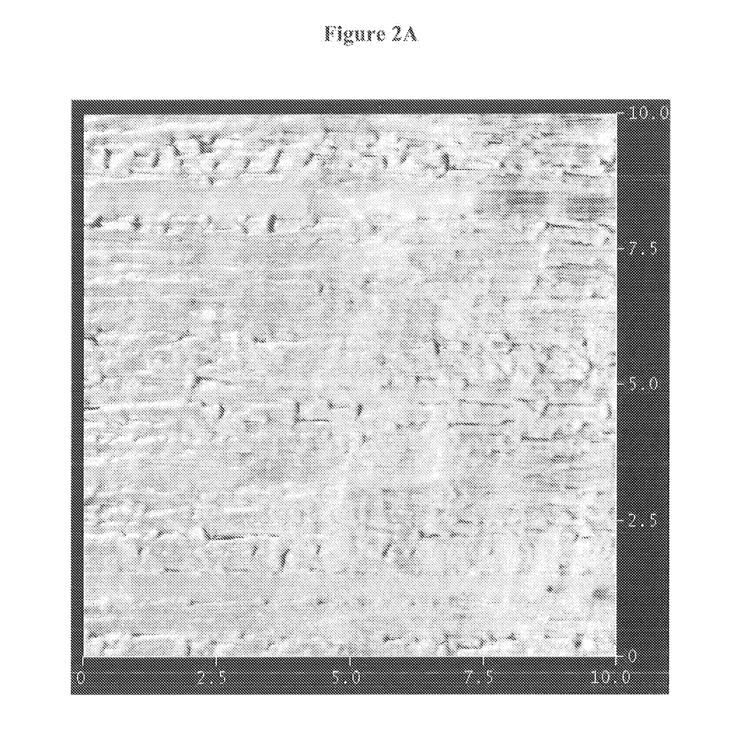

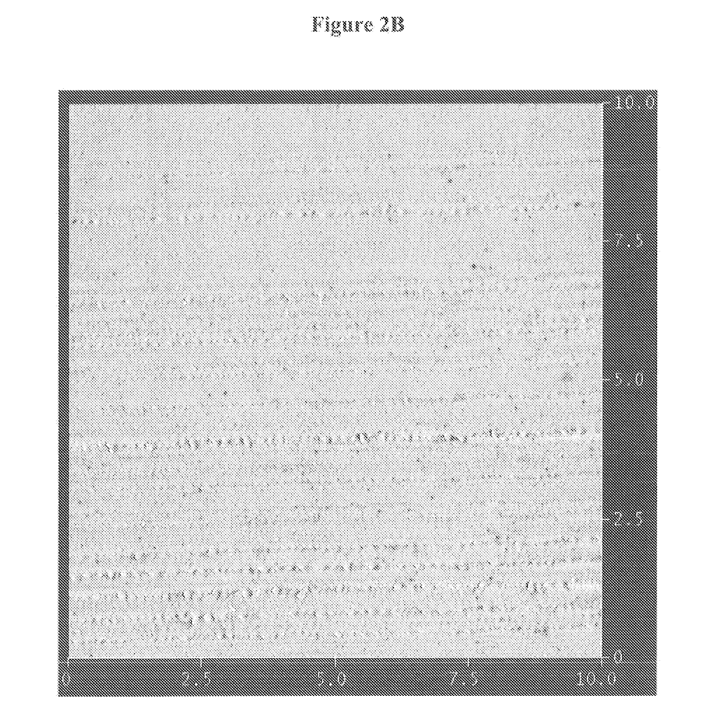

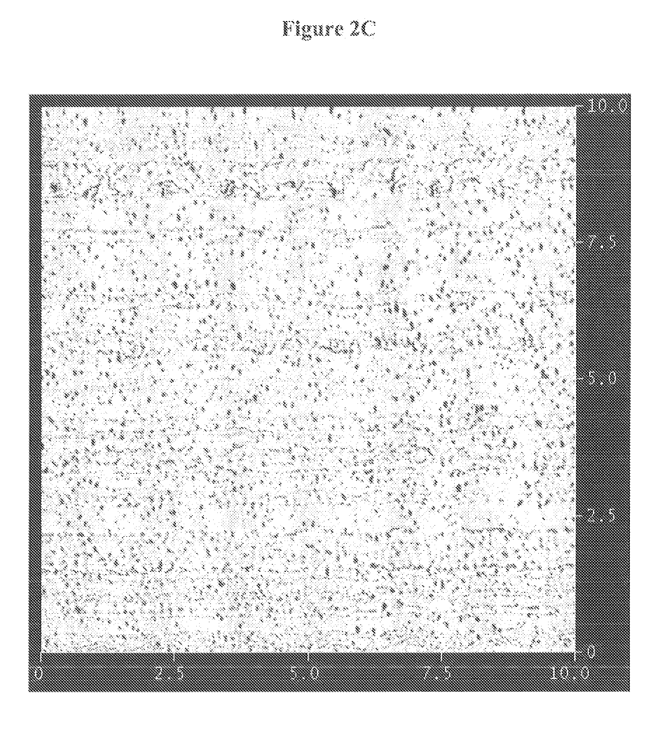

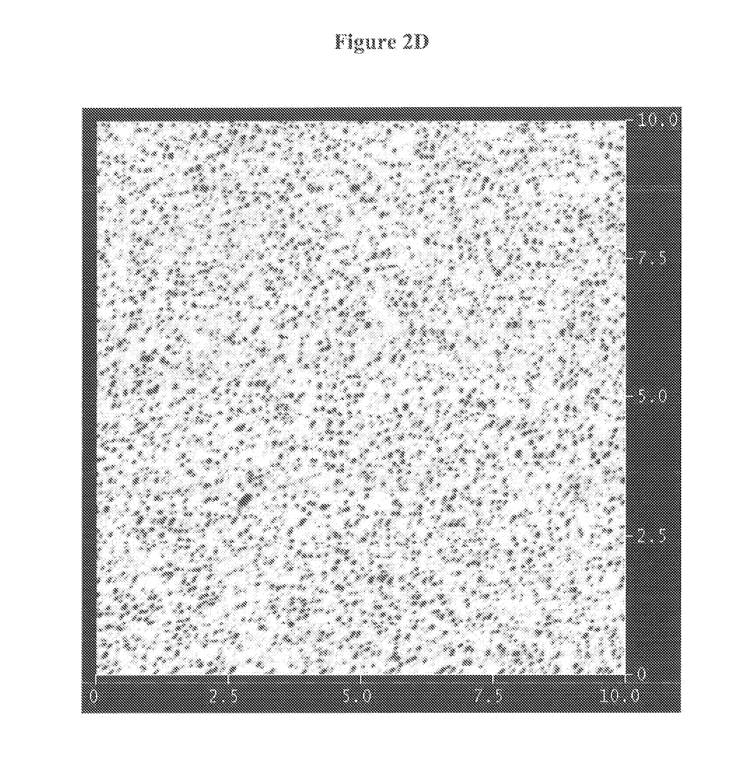

However, as the loading of stearyl methacrylate and mineral oil increased, the haziness also increased. FIG. 2 shows the results of atomic force microscopy (AFM) of four samples of the styrenic copolymer of Runs 1, 5, 9, and 13 having various amounts of StMA and without mineral oil, with dimensions given in microns. FIG. 2 a) depicts a styrenic copolymer having 5 wt % StMA, b) depicts a styrenic copolymer having 10 wt % StMA, c) depicts a styrenic copolymer having 15 wt % StMA, and d) depicts a styrenic copolymer having 20 wt % StMA. FIG. 2 shows that the size of insoluble domains increased as the amount of StMA increased. At both 5 and 10 wt % StMA levels, the AFM results were uniform and only showed a slight amount of variation. However, nano-sized domains started to appear at 15 wt % loading of StMA and these nano-sized domains further increased in size from about 25 to about 75 nm at the 20 wt % loading level.

### Example 2

To obtain an indication of the brittleness of each formulation, differential scanning calorimetry was run on each sample and the results are shown in Table 2. For every percent StMA substituted into the formulation the glass transition temperature dropped approximately 4° C. Also, for every percent mineral oil substituted into the formulation, the glass transition temperature dropped approximately 5° C. At higher loadings of both, 20 wt % StMA with 2, 4 or 6 wt % mineral oil, the glass transition temperature was suppressed to below room temperature and the materials resembled a plasticized PVC, or toughened rubber, like EPDM (ethylene propylene diene Monomer (M-class)) rubber.

Instrumented tensile impact (ITI) measurements, a high speed test carried out at velocities of 2.9 to 3.6 meters/sec, were run on the test strips and the physical properties of the samples were assessed using these measurements. ITI measurements were conducted per ASTM 1822-06. The results of these measurements are shown in Table 2. When tested with ITI, GPPS generally exhibits high tensile properties, and low impact and ductile properties. This is exemplified by the data presented for Total 500, which is a GPPS commercially available from Total Petrochemicals, Inc. The elongation is one percent or less, and the impact strength is less than 0.1 J. In contrast Total 975E, which is a high-impact polystyrene (HIPS) commercially available from Total Petrochemicals, Inc., contains 8.5% rubber and has an impact strength of 1.5 J, and an elongation of 15.6%. The materials with glass transition temperatures below room temperature (Runs 2, 3 and 4) possessed very high impact energies and elongations. In general the ductility, as measured by elongation, and the impact strength increased with both mineral oil content and StMA content. This corresponded to a decrease in the tensile strength and modulus. In general, all of the copolymers demonstrated elongation and impact energies around four times greater than the GPPS sample, making them suitable for some clear-impact applications.

Embodiments of the present invention have at least two times the impact strength compared to GPPS as observed by ITI. Alternate embodiments have at least four times the impact strength compared to GPPS as observed by ITI. Embodiments can have an impact strength of at least 0.2 J, optionally at least 0.25 J, optionally at least 0.3 J, optionally at least 0.4 J, optionally at least 0.5 J, optionally at least 0.75 J, optionally at least 1.0 J, optionally at least 1.5 J.

Runs 2 through 4 were made with 20 wt % alkyl methacrylate, and each contained mineral oil. These runs showed surprising results of tensile impact (J) of from 1.7 to 2.03 and elongation of greater than 100%. These results indicate a synergistic effect of high levels of alkyl methacrylate with mineral oil. Embodiments of the present invention have an alkyl acrylate and/or alkyl methacrylate in amounts greater than 15 wt % of the reaction mixture and have mineral oil in amounts greater than 0.1 wt % of the reaction mixture that produce a polymerization product having elongation of at least 20% and tensile impact of at least 0.5 J. Alternate embodiments have alkyl acrylate and/or alkyl methacrylate in amounts greater than 17 wt % of the reaction mixture, optionally from 15 wt % to 30 wt %, optionally from 17 wt % to 25 wt %, optionally from 18 wt % to 23 wt %. Alternate embodiments have mineral oil in amounts greater than 0.5 wt % of the reaction mixture, optionally from 0.1 wt % to 10 wt %, optionally from 0.2 wt % to 8 wt %, optionally from 0.5 wt % to 8 wt %. Embodiments of the present invention can produce a polymerization product having elongation of at least 20%, optionally at least 40%, optionally at least 80%. Embodiments of the present invention can produce a polymerization product having tensile impact strength of at least 0.5 J, optionally at least 1.0 J, optionally at least 1.5 J. Embodiments of the present invention can have at least ten times the impact strength compared to GPPS as observed by ITI, optionally at least thirty times the impact strength compared to GPPS, optionally at least one hundred times the impact strength compared to GPPS.

In Table 2, H represents hazy, O represents opaque and C represents clear. Also, the numbers in italics, which are the Tg values for Runs 2, 3 and 4, represent an extrapolated value. As used herein a Hazy designation is having a transmission >50% and haze of <30%; an Opaque designation is having a transmission <10% and haze of >70%; and a Clear designation is having a transmission >85% and haze of <5%.

TABLE 2
Physical Properties of Styrene-co-Stearyl Methacrylate Copolymers

| Run | 1 | 2 | 3 | 4 | 5 | 6 | 7 | 8 | 9 | 10 |
|---|---|---|---|---|---|---|---|---|---|---|
| Clarity | H | H | H | H | C | C | O | O | C | C |
| Formulation | | | | | | | | | | |
| Styrene, wt % | 80 | 78 | 76 | 74 | 85 | 83 | 81 | 79 | 90 | 88 |
| Alkyl | 20 | 20 | 20 | 20 | 15 | 15 | 15 | 15 | 10 | 10 |
| Methacrylate, wt % | | | | | | | | | | |
| Rubber, wt % | — | — | — | — | — | — | — | — | — | — |
| Mineral Oil, wt % | 0 | 2 | 4 | 6 | 0 | 2 | 4 | 6 | 0 | 2 |
| Glass Transition | | | | | | | | | | |
| Tg (inflection), C. | 31.1 | 24.1 | 17.4 | 11.0 | 47.6 | 39.8 | 32.4 | 25.3 | 66.0 | 57.3 |
| Physical Properties | | | | | | | | | | |
| Tensile Strength, MPa | 27.8 | 19.2 | 12.4 | 12.8 | 22.1 | 21.5 | 15.0 | 28.7 | 16.8 | 14.8 |
| Tensile Modulus, MPa | 458 | 366 | 262 | 145 | 685 | 634 | 569 | 612 | 562 | 700 |
| Tensile Impact, J | 0.21 | 2.03 | 1.7 | 1.96 | 0.30 | 0.40 | 0.50 | 0.50 | 0.12 | 0.35 |
| Elongation, % | 3.6 | >100 | >100 | >100 | 3.2 | 3.4 | 2.7 | 3.7 | 3.3 | 3.2 |

| Run | 11 | 12 | 13 | 14 | 15 | 16 | 500 | 975E |
|---|---|---|---|---|---|---|---|---|
| Clarity | H | H | C | C | H | H | C | O |
| Formulation | | | | | | | | |
| Styrene, wt % | 86 | 84 | 95 | 93 | 91 | 89 | 100 | 88.75 |
| Alkyl | 10 | 10 | 5 | 5 | 5 | 5 | — | — |
| Methacrylate, wt % | | | | | | | | |
| Rubber, wt % | — | — | — | — | — | — | — | 8.5 |
| Mineral Oil, wt % | 4 | 6 | 0 | 2 | 4 | 6 | — | 2.75 |
| Glass Transition | | | | | | | | |
| Tg (inflection), C. | 49.0 | 41.2 | 86.6 | 76.8 | 67.6 | 58.8 | 106.0 | 106.0 |
| Physical Properties | | | | | | | | |
| Tensile Strength, MPa | 13.9 | 12.3 | 23.9 | 18.0 | 14.1 | 11.3 | 43.6 | 29.6 |
| Tensile Modulus, MPa | 569 | 578 | 943 | 764 | 614 | 482 | 2530 | 1620 |
| Tensile Impact, J | 0.32 | 0.38 | 0.17 | 0.40 | 0.48 | 0.30 | 0.09 | 1.5 |
| Elongation, % | 3.5 | 3.4 | 3.6 | 3.6 | 3.4 | 2.4 | 1.1 | 15.6 |

As used herein the term “clear” means the article has a total white light transmission (TWLT) greater than 85% and haze less than 5%, as measured according to ASTM D1003 and E313.

As used herein the term “hazy” means the article has a total white light transmission (TWLT) greater than 50% and haze less than 30%, as measured according to ASTM D1003 and E313.

As used herein the term “opaque” means the article has a total white light transmission (TWLT) less than 10% and haze greater than 70%, as measured according to ASTM D1003 and E313.

As used herein, the term “co-polymer,” also known as a “heteropolymer,” is a polymer resulting from polymerization of two or more monomer species. The term “co-polymer” is includes of all types of co-polymers including random co-polymers and block co-polymers.

As used herein, the term “copolymerization” refers to the simultaneous polymerization of two or more monomer species.

As used herein, the term “polymer” generally includes, but is not limited to homopolymers, co-polymers, such as, for example, block, graft, random and alternating copolymers, and combinations and modifications thereof.

As used herein, the term “monomer” refers to a relatively simple compound, usually containing carbon and of low molecular weight, which can react by combining one or more similar compounds with itself to produce a polymer.

As used herein, the term “co-monomer” refers to a monomer that is copolymerized with at least one different monomer in a copolymerization reaction resulting in a copolymer.

Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

The various embodiments of the present invention can be joined in combination with other embodiments of the invention and the listed embodiments herein are not meant to limit the invention. All combinations of various embodiments of the invention are enabled, even if not given in a particular example herein.

While illustrative embodiments have been depicted and described, modifications thereof can be made by one skilled in the art without departing from the spirit and scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

Depending on the context, all references herein to the “invention” may in some cases refer to certain specific embodiments only. In other cases it may refer to subject matter recited in one or more, but not necessarily all, of the claims. While the foregoing is directed to embodiments, versions and examples of the present invention, which are included to enable a person of ordinary skill in the art to make and use the inventions when the information in this patent is combined with available information and technology, the inventions are not limited to only these particular embodiments, versions and examples. Other and further embodiments, versions and examples of the invention may be devised without departing from the basic scope thereof and the scope thereof is determined by the claims that follow.

What is claimed is:

1. A styrenic copolymer composition comprising:
a styrenic copolymer produced from the polymerization of styrene monomer with at least one comonomer selected from the group consisting of alkyl acrylate, alkyl methacrylate, and combinations thereof;
wherein the styrenic copolymer is optically clear and has at least two times the impact strength as compared to GPPS.

2. The composition of claim 1, wherein the alkyl acrylate comprises an alkyl group having from 8 to 12 carbon atoms.

3. The composition of claim 1, wherein the alkyl methacrylate comprises an alkyl group having equal to or greater than 10 carbon atoms.

4. The composition of claim 1 wherein the alkyl acrylate is selected from the group consisting of octyl acrylate, nonyl acrylate, decyl acrylate, undecyl acrylate, dodecyl acrylate, and combinations thereof.

5. The composition of claim 1, wherein the alkyl methacrylate is selected from the group consisting of isodecyl methacrylate, endecyl methacrylate, stearyl methacrylate, and combinations thereof.

6. The composition of claim 1, having impact strength of at least 0.2 J.

7. The composition of claim 1, wherein the at least one comonomer is present in an amount ranging from 1.0 to 30 wt. % by total weight of the composition.

8. The composition of claim 1, further comprising an oil having a refractive index of at least 1.40, in an amount ranging from 0.1 to 8 wt. % by total weight of the composition.

9. The composition of claim 8, comprising an oil having a refractive index of at least 1.40, in an amount ranging from 0.5 to 3 wt. % by total weight of the composition and the comonomer is present in an amount ranging from 2.0 to 17 wt. % by total weight of the composition; wherein the composition has an impact strength of at least 0.2 J.

10. The composition of claim 9, wherein the oil has a refractive index of from 1.45 to 1.50.

11. The composition of claim 9, wherein the oil has a refractive index of from 1.46 to 1.48.

12. The composition of claim 9, wherein the oil is mineral oil.

13. The composition of claim 9, wherein the comonomer is stearyl methacrylate.

14. The composition of claim 9, wherein the composition has an impact strength of at least 0.3 J.

15. An article of manufacture made from the styrenic copolymer composition of claim 1.

16. A styrenic copolymer composition comprising:
a styrenic copolymer produced from the polymerization of styrene monomer with at least one comonomer selected from the group consisting of alkyl acrylate, alkyl methacrylate, and combinations thereof;
an oil having a refractive index ranging from 1.40 to 1.55 present in an amount of from 0.1 wt. % to 8.0 wt. % by total weight of the composition;
wherein the styrenic copolymer composition has at least two times the impact strength compared to GPPS.

17. The composition of claim 16, wherein the comonomer is present in an amount of at least 15 wt. % by total weight of the composition, and wherein the composition has elongation of at least 20% and a tensile impact of at least 0.5 J.

18. The composition of claim 16, wherein the comonomer is present in an amount of at least 17 wt. % by total weight of the composition, and wherein the composition has elongation of at least 40% and a tensile impact of at least 1.0 J.

19. The composition of claim 16, wherein the comonomer is present in an amount of from 17 wt. % to 30 wt. % by total weight of the composition, and wherein the composition has elongation of at least 80% and a tensile impact of at least 1.5 J.

20. An article of manufacture made from the styrenic copolymer composition of claim 16.
